(19) United States
(12) Patent Application Publication
(10) Pub. No.: US 2014/0215096 A1
(43) Pub. Date: Jul. 31, 2014

(54) METHOD AND SYSTEM FOR A CONFIGURABLE HARDWARE MODULE

(71) Applicant: GE INTELLIGENT PLATFORMS, INC., Charlottesville, VA (US)

(72) Inventor: Gary Lawrence Pratt, Hartland, WI (US)

(73) Assignee: GE INTELLIGENT PLATFORMS, INC., Charlottesville, VA (US)

(21) Appl. No.: 13/751,471

(22) Filed: Jan. 28, 2013

(51) Int. Cl. G06F 9/44; G06F 13/40

(52) U.S. Cl. CPC G06F 9/4411; G06F 13/409
USPC 710/8; 710/313; 710/62

(57) ABSTRACT

Provided is a programmable logic system for controlling an external device including a first processor and one or more system input/output (I/O) modules coupled to the processor via an interface. The programmable logic system also includes a configurable hardware module coupled to the processor and the I/O modules via the interface.

### I. FIELD OF THE INVENTION

The present invention relates generally to configurable hardware modules. More particularly, the present invention relates to user configurable hardware in a programmable control module, such as a programmable logic controller (PLC).

### II. BACKGROUND OF THE INVENTION

Advancements in critical infrastructure, such as improvements in energy production, water purification etc., have created an even greater need for autonomous, remote, and accurate infrastructure control systems. These control systems facilitate operation of the massive machines and other devices that represent the heart of critical infrastructure.

By way of example, gas turbine engines (e.g., jet engines) are routinely used in ground applications for producing electricity, controlling the flow of gasoline via gas pipelines, and in other applications where significant amounts of power are needed. Gas turbine engines, for example, are smaller than diesel engines (roughly 4000 horsepower (hp)), but are significantly more powerful—generating about 40,000 hp. In fact, many coal-fired power plants will be replaced with gas turbines that can use natural gas, which is a much more efficient and less polluting source of energy than coal.

Even as renewable energy sources, like wind and solar, become more mainstream, a need still exists for adequate backup energy sources. Since electricity cannot be stored in any meaningful way, when the wind dies there must always be sufficient backup energy to supply the ongoing energy demands previously met by the wind energy source. Gas turbines are used as backup energy generators to meet these ongoing energy demands.

Turbines are unique in the unusually quick response time needed to control the engine. In a production line, or other PLC application, if an operation took a few extra tenths of a second, it would likely not impact the operation. In a turbine, operations must typically be done in less than 10 ms, to protect the engine from damage. Although gas turbines are significant, turbines are but one example of the machines and other devices whose control is fundamental our critical infrastructure.

In the case of gas turbines, such as jet engines, a natural assumption might be to use the same control system that is currently used on airplanes. However, the conditions under which jet engines are used on airplanes are much different than those of ground based applications. For example, factors such as wind velocity and the absolute requirement continuous operation, are only issues on airplanes. A slightly different approach is required when jet engines, and other gas turbines, are used in ground-based applications.

Many traditional systems exist for controlling gas turbines, and similar devices, in ground based applications. These traditional approaches generally fall into two categories: single-purpose systems and general-purpose systems.

Given the low-volume in which gas turbines are produced and used for ground-based purposes, single-purpose control systems tend to be extremely costly. Also, the engineering costs for maintenance of these low-volume single-purpose control systems can only be spread over limited number of customers. This causes maintenance of older designs to become prohibitively expensive, forcing consumers to replace entire systems when one part becomes obsolete.

General-purpose off-the-shelf control systems offer many advantages. Although, significantly cheaper than single-purpose control systems, however, general-purpose systems tend to lack the precision and high-performance capabilities required for many of the evolving ground-based gas turbine control environments.

### III. SUMMARY OF EMBODIMENTS OF THE INVENTION

Given the aforementioned deficiencies, a need exists for a cost-effective, off-the-shelf device control system capable of meeting the high performance ground-based demands of gas turbines and other devices used in critical infrastructure systems. A need also exist for a user configurable hardware module capable flexibly adapting to different devices operating under different conditions.

Embodiments of the present invention, under certain circumstances, provide a programmable logic system for controlling an external device, including a first processor and one or more system input/output (I/O) modules coupled to the processor via an interface. The programmable logic system also includes a configurable hardware module coupled to the processor and the I/O modules via the interface.

In another illustrious embodiment, a configurable hardware module includes a bus configured for coupling the hardware module to an external interface and a processor having a first port coupled to the bus. The configurable hardware modules includes an external input/output (I/O) module having one port coupled to a second port of the processor and another port configured for coupling to an external device.

In yet another embodiment, provided is a computer readable medium having stored thereon computer executable instructions that, if executed by a computing device, cause the computing device to perform a method including creating one or more configuration files related to the operation of the device. The method also includes programming configurable logic within a field programmable gate array (FPGA) in accordance with the configuration files and controlling the operation of the device with the programmed FPGA via an input output module.

Specific implementations of some of the embodiments, to which the present invention is not limited, rely on the use of programmable logic controllers (PLCs). More specifically, the embodiments of the invention expand the flexibility and utility of PLCs by implementing user-configurable hardware in a PLC I/O module. This configurable hardware allows these PLCs to expand into markets requiring functionality which is high-performance, highly specialized, unusually complex, or requires a high safety integrity level (SIL) certification.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### IV. BRIEF DESCRIPTION OF THE DRAWINGS

The accompanying drawings, which are incorporated herein and form part of the specification, illustrate the present invention and, together with the description, further serve to explain the principles of the invention and to enable a person skilled in the relevant art(s) to make and use the invention.

FIG. 1 is an illustration of a high level operational view of a hardware control system constructed in accordance with embodiments of the present invention;

FIG. 2 is a block diagram illustration of a hardware control module shown in the system of FIG. 1;

FIG. 3 is a block diagram illustration of a hardware control module constructed in accordance with a second embodiment of the present invention;

FIG. 4 is a block diagram illustration of a hardware control module constructed in accordance with a third embodiment of the present invention; and

FIG. 5 is a flowchart of an exemplary method of practicing an embodiment of the present invention.

### V. DETAILED DESCRIPTION OF EMBODIMENTS OF THE INVENTION

While the present invention is described herein with illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

Embodiments of the present invention are particularly applicable to low-volume high-performance markets where the limited market volume cannot justify custom module development and/or our current module offering does not provide the performance necessary for high-performance niche markets. The embodiments are also particularly helpful in new markets where conditions do not allow sufficient time to develop a new module to control a specific device, such as a gas turbine.

The embodiments significantly reduce the verification and validation (V&V) time required for a typical new module development—moving the responsibility for verification and validation into the user domain (where the responsibility for the V&V of all the other user programming currently resides). It also provides an enhanced level of flexibility without the complexities normally associated with verifying and validating all of the potential permutations of a highly flexible device.

Other embodiments of the present invention provide sufficient segmentation to allow SIL-3 certified functionality in a configurable hardware module without the need to SIL-3 certify the entire PLC.

By way of example, and not limitation, embodiments of the present invention make extensive use of programmable devices, such as FPGAS and complex programmable logic devices (CPLDs). These programmable devices also enable the embodiments to meet the high-performance requirements of ground turbine control systems. These systems often involve the use of high-performance pressure sensors, high repetition rate serial communication to multiple high-speed servo control valves, and achieve high resolution speed measurement of turbine rotational speeds with SIL-3 certified safety shutdown.

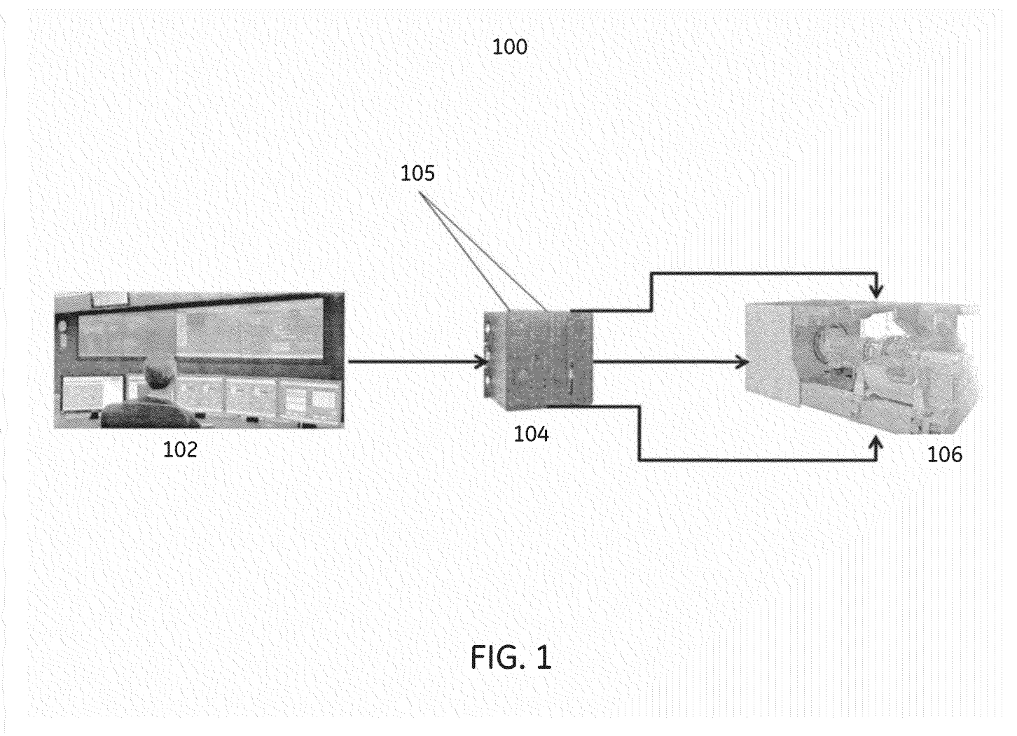

FIG. 1 is an illustration of a high level view a hardware control system 100, constructed in accordance with an embodiment of the present invention. Broadly, the system 100 provides programmable software, programmable hardware, and a fixed physical layer.

As illustrated in FIG. 1, the system 100 includes a logic control room graphical interface 102 and a control rack 104. The control rack 104 includes functional modules 105, each focused on controlling an external device, such as gas-turbine jet engine 106. During operation, the graphical interface 102 enables the user to control the operation of the gas turbine 106 via the logic control rack 104.

The exemplary control rack 104 includes the modules 105, each of which is configured to facilitate control of all aspects of the gas turbine 106. By way of example, an actual rack, such as the logic control rack 104, can include about 20 modules, similar to the modules 105. One module, for example, will typically be a power supply. Positioned close to the power supply is usually a computer processor, along with several other special purpose modules, enabling the user to perform whatever tasks are required.

In the example above, one module can monitor pressure, another module can monitor one or more specific sensors, and other modules might monitor the speed of the turbine.

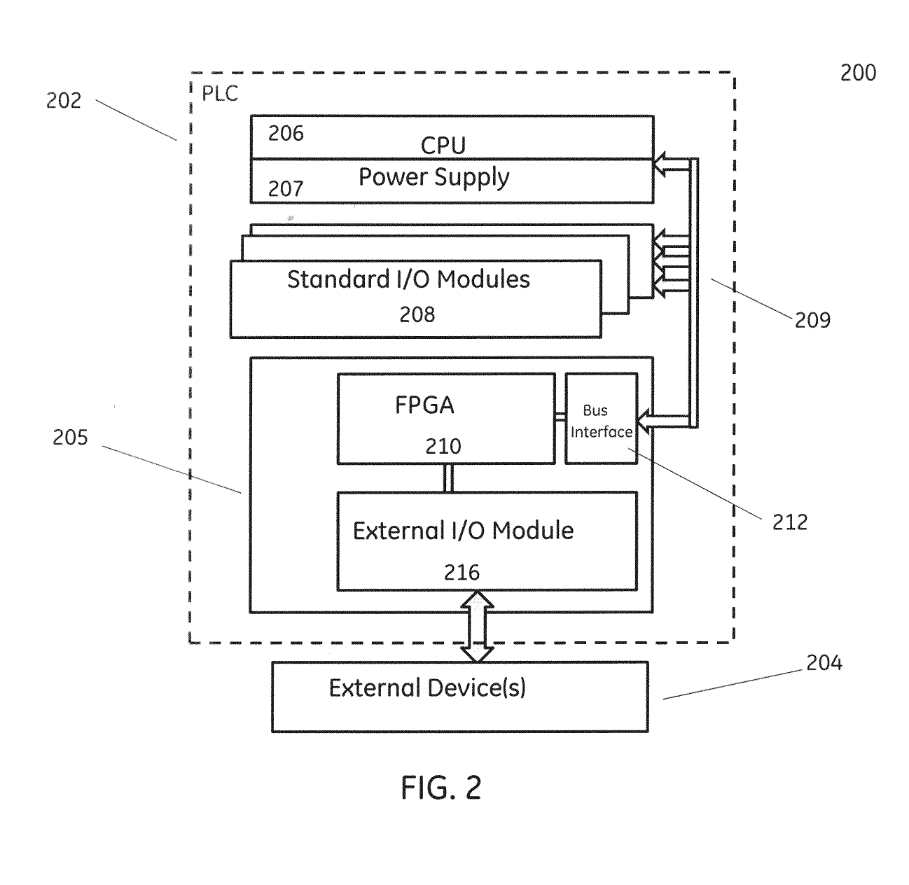

FIG. 2 is a block diagram illustration 200 of the logic control rack 104, shown in the system 100 of FIG. 1. Provided is a hardware control system 202 configured for controlling one or more external devices 204. As shown in the example of FIG. 1, the external devices can include a gas turbine engine, such as the engine 106, and the like.

The hardware control system 202 is capable of controlling all aspects of the devices 204. In the exemplary hardware control system 202, the aforementioned functions are created using user-level logic on a configurable hardware module 205, discussed in greater detail below.

The exemplary hardware control system 202 includes a degree of flexibility and high-performance available from an FPGA, combining the benefits of single-purpose and general-purpose systems. In the hardware control system 202, however, customer testing of any unique application involves far less effort than would be required for manufacturer testing of all possible applications of a conventional general-purpose system.

As an example of flexibility, embodiments of the invention allow development engineers, application engineers, thirds party developers, and customers to rapidly implement new functionality and improve performance to capture new business markets dependent on the required features and performance goals. The embodiments also provide speedy resolution of issues that may arise in the field, ultimately resulting in enhanced user satisfaction.

The hardware control system 202 also includes a central processing unit (CPU) 206 and a power supply 207. The CPU 206, among other things, manages operation of the other modules within the hardware control system 202. Also included are standard I/O modules 208. The standard I/O modules 208 are interconnected to each other, to the CPU 206, to the power supply 207, and to other modules within the hardware control system 202 via a standard interface 209. The interface 209 can be implemented in the form of an RS-232 physical layer, peripheral component interconnect (PCI), PCI express (PCIe), Ethernet, EtherCat, and other standard and custom means of communication from a master to multiple other devices.

The configurable hardware module 205 includes an FPGA 210, a standard bus interface 212, and external I/O modules 216. As can be seen in the exemplary embodiment illustrated in FIG. 2, the FPGA 210 is placed between the bus interface 210 and an external I/O module 216. The external I/O module 216 facilitates communication between the configurable hardware module 205 and the outside world. The present invention is not limited to the embodiment illustrated in FIG. 2.

The ability of the exemplary configurable hardware module 205 to adapt to and accommodate the operational modes of the external device is premised upon the use of configurable logic. By way of example, and not limitation, this configurable logic can be implemented with a current state-of-the-art FPGA integrated circuit (IC), such as the FPGA 210 or a CPLD. A portion of the FPGA 210 contains fixed logic for interfacing to the bus 212, the external I/O module 216, and for receiving and loading configurable logic programming from the user.

During an exemplary operational scenario, the CPU 206 will transmit read and write messages, representative of the identification number of a particular external device as a protocol to confirm device identity and to ascertain related register values. This communication exchange will then be converted into a format to enable corresponding registers, within the FPGA 210, to read and write and understand their tasking

The bus interface 212, which can be implemented in accordance with peripheral component interconnect (PCI) standards uses specific voltages (i.e., a physical layer) that are converted into an appropriate physical layer consistent with communications protocols within the FPGA 210. This process is well understood by those of skill in the art and, therefore, will not be expanded upon herein. Although the bus interface 212 is shown to be external to the FPGA 210, other embodiments can include the bus interface 212 internal to the FPGA 210.

User programming of the FPGA 210 can be similar to how C-Block programs are currently implemented in existing PLCs. The user can use approved external tools (either from an FPGA vendor or from a third party tool vendor), well known to those of skill in the art, to create a downloadable configuration file.

The configuration file can then be imported into the PLC programming tool and associated with a specific task required to be performed by the configurable hardware module 205. By way of example, when the user program has been downloaded to the system 202, the loader will also transfer the FPGA configuration to the appropriate module which will then be loaded into the FPGA 210.

The loader (not shown) can also optionally copy the program to nonvolatile random access memory (NVRAM) within the configurable hardware module 205 so that the module can power-up with the user-program intact and ready to use.

While FIG. 2 uses multiple digital I/O modules, as in the case of the standard I/O modules 208 and the external I/O module 216, the invention is not limited to this particular I/O implementation. As known to those of skill in the art, a family of such modules could include analog I/O, and various network physical layer hardware, as well.

Although the hardware control system 202 includes an FPGA 210, other embodiments of the present invention could replicate the functionality of the FPGA 210 using a CPU, a graphics processing unit (GPU), an accelerated processing device (APD), or a multi-core version of combinations thereof. Standard programming languages can also be used to replicate hardware functionality in software.

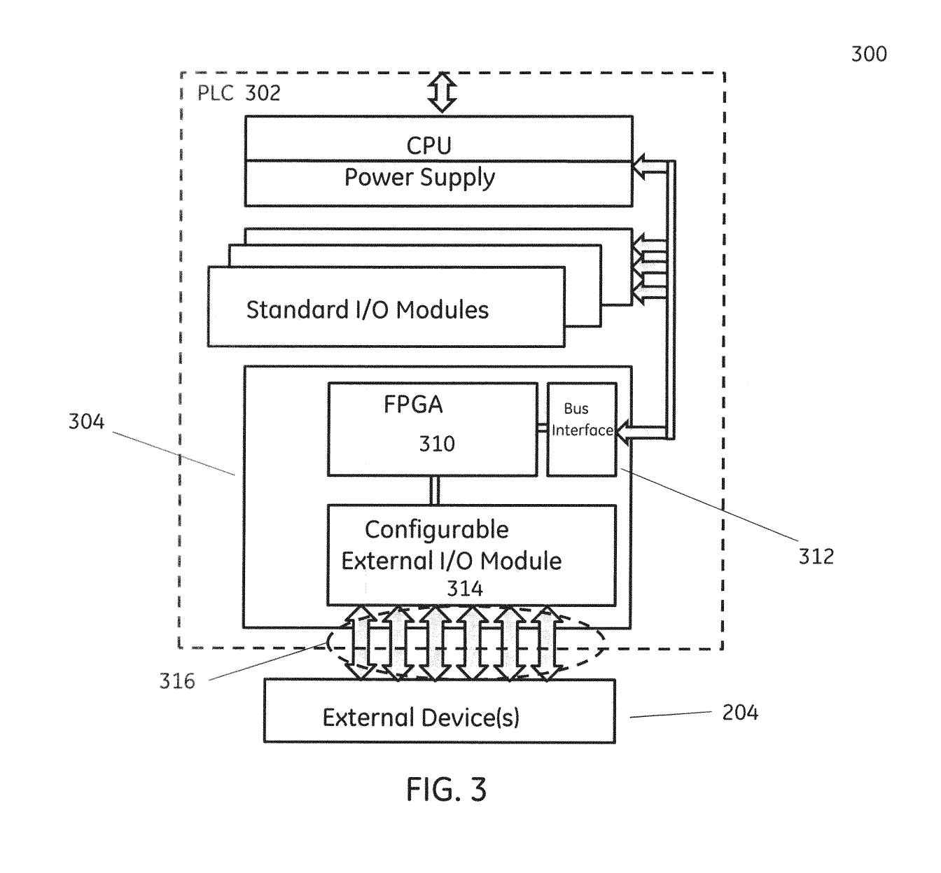

The embodiment illustrated in FIG. 3 extends the programmability concept of the system 202 of FIG. 2 to into a system 302 that includes programmable software, programmable hardware, and a programmable physical layer. In the illustrious system of FIG. 3, if external devices, such as temperature or pressure sensors were used, one would need a different physical layer. Therefore, a different I/O module could be needed for each device.

For example, one might need a configured (i.e., dedicated) I/O module for the pressure sensor, a configured I/O module for the temperature sensor and a configured module for a serial port. The exemplary hardware control system of FIG. 3, discussed more fully below, provides a configurable external I/O module 314 that simplifies this process.

More specifically, FIG. 3 is a block diagram illustration 300 of a hardware control module 302 constructed in accordance with a second embodiment of the present invention. As illustrated in FIG. 3, in addition to the CPU, power supply, and standard I/O modules of the system 202, the hardware control system 302 includes its own configurable hardware module 304. The configurable hardware module 304 includes an FPGA 310, a bus interface 312, and a configurable external I/O module 314 configurable to provide various forms of analog, digital, or communication I/O via an external interface 316.

As well understood by those of skill in the art, the configurable I/O 314 can be implemented in several different ways, including but not limited to:

(a). a custom application specific integrated circuit (ASIC), standard IC, and/or as discrete hardware placed on the FPGA board.

(b). a custom ASIC, standard IC, and/or as discrete hardware placed on a second adjacent board in the module. (This allows a selection of I/O boards to be stocked without the expense of duplicate FPGA and interface hardware. It also allows new I/O boards to be developed without impacting the design or certification of the FPGA/Interface board.)

(c). implement in an adjacent module with a new interface provided between the two Modules. (This provides the same benefits as (b), but the combination can be chosen and configured in the field; and since it uses two slots, it has more power consumption flexibility.)

(d). as an interface to off-the-shelf or custom I/O terminal blocks.

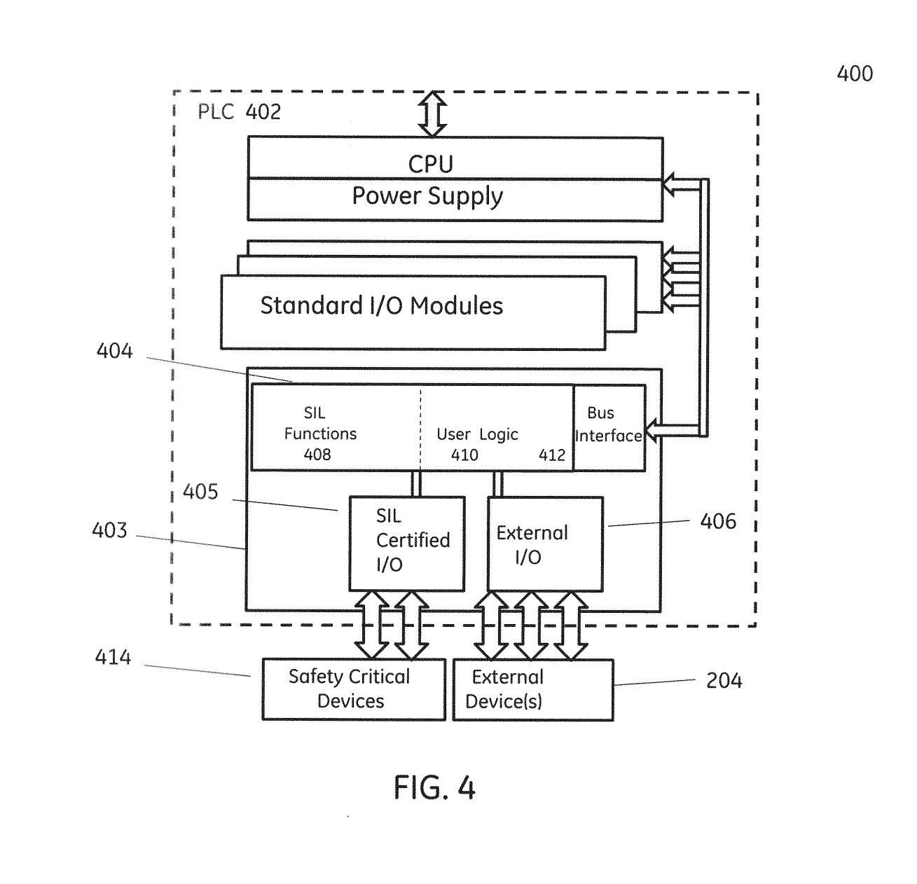

FIG. 4 is a block diagram illustration 400 of a hardware control system 402 constructed in accordance with a third embodiment of the present invention. In FIG. 4, the hardware control system 402 can be utilized to provide SIL-3 level functionality. In this embodiment, a limited number of functional blocks with a limited number of configurable parameters are created for various safety functions. Due to the limited number of permutations and the fact that the function is implemented in hardware rather than software, SIL-3 certification is feasible.

In the system 402, the SIL-3 certified logic is implemented inside of an FPGA. More specifically, the hardware control system 402 includes, among other things, the configurable hardware module 403. Included within the configurable hardware module 403 is an FPGA 404, a SIL-3 certified I/O 405, and an external I/O 406. The FPGA 404 includes a SIL-3 functions modules 408, a user logic module 410, and a bus interface 412. It is anticipated that aspects of the SIL-3 module, the user logic, and the bus interface may be replicated within a CPU, a GPU, or an APD. In the embodiment of FIG. 4, a portion of the FPGA 404 is reserved for SIL-3 functions.

Additionally, the SIL-3 certified I/O 405 has been designed and verified to SIL-3 standards. In the exemplary embodiment, SIL-3 can be achieved in an FPGA because the number of variables in the FPGA 404 is sufficiently small such that all possible permutations can be analyzed and certified. In the present application, the term variables is used to denote moving parts, paths, permutations, and/or dependencies. Variables is not intended to denote a real number.

Generally, software approaches to flexibility include too many variables for this to be practical. In software, these variable can include interrupts, operating systems, branch conditions, typically thousands or millions of individual machine instructions chained together to form the computer program, etc. By way of example, the SIL-3 functions for the FPGA 404 might include 2, 3, and 4 input AND blocks, 2, 3, and 4 input OR blocks, a SET/Reset block, etc. These blocks are directly implemented in hardware, and there are only a limited number of ways they can be interconnected. Thus, PFD (Probability of Failure on Demand) can be readily calculated.

In the embodiment of FIG. 4, SIL-3 certified hardware configurations are carried out on inputs obtained from the SIL-3 certified I/O 405 and the results of the functions are placed on the outputs via the SIL-3 certified I/O. All other routine instructions are forwarded via the external I/O 406 external devices 204.

In the exemplary embodiments of the present intention, a distinction can be made between the terms “hardware configurations” and “software instructions.” For example, in software, an instruction might be:

1) Get input from I/O A.

2) Get input from Input B.

3) Perform a logical AND on the values from input A and B.

4) Output the results to Output C.

In a hardware, execution of these operations would be different. A hardware configuration, for example, may be more analogous to having one outlet strip plugged into another (A and B). If the switch on outlet strip A is on AND the switch on outlet strip B is on, whatever is plugged into B will be on. In this arrangement, there are no instructions: it just happens because the hardware is configured to behave in this manner.

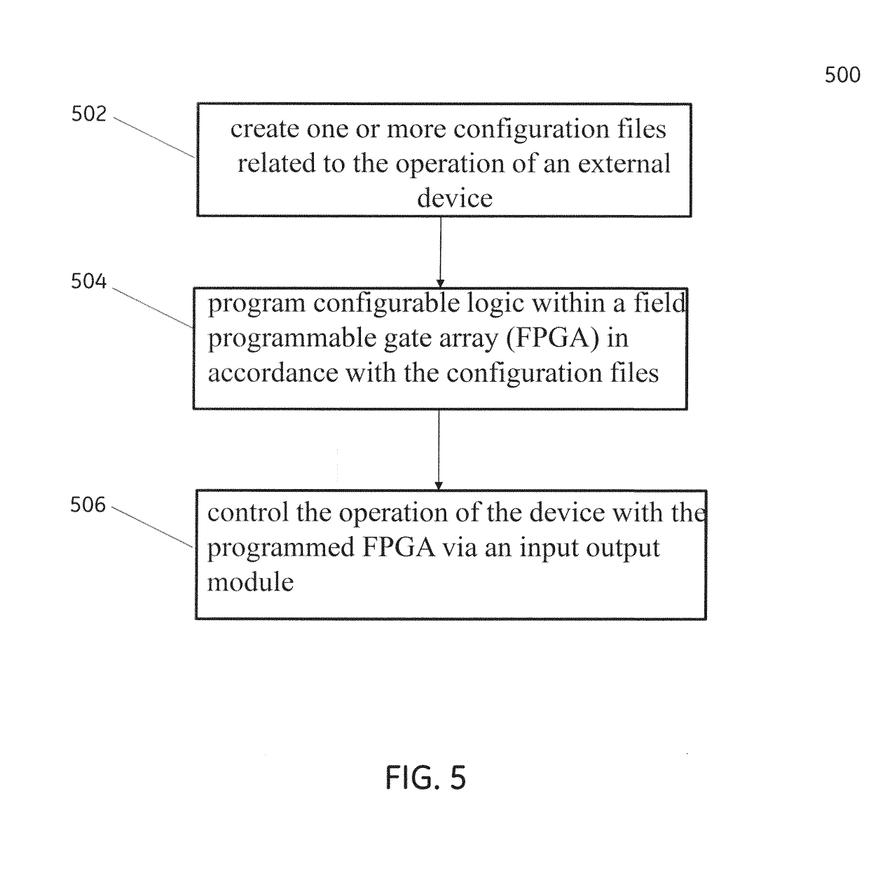

FIG. 5 is a flowchart of an exemplary method 500 of practicing an embodiment of the present invention. In FIG. 5, the method 500 creates one or more configuration files related to the operation of external device, as illustrated in step 502. In step 504, logic within an FPGA, such as the FPGA 210, is programmed in accordance with the created configuration files. In step 506, the operation of the external device is controlled based upon the programmed FPGA via an I/O module.

### CONCLUSION

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

For example, various aspects of the present invention can be implemented by software, firmware, hardware (or hardware represented by software such, as for example, Verilog or hardware description language instructions), or a combination thereof. After reading this description, it will become apparent to a person skilled in the relevant art how to implement the invention using other computer systems and/or computer architectures.

It should be noted that the simulation, synthesis and/or manufacture of the various embodiments of this invention can be accomplished, in part, through the use of computer readable code, including general programming languages (such as C or C++), hardware description languages (HDL) including Verilog HDL, VHDL, Altera HDL (AHDL) and so on, or other available programming and/or schematic capture tools (such as circuit capture tools).

This computer readable code can be disposed in any known computer usable medium including semiconductor, magnetic disk, optical disk (such as CD-ROM, DVD-ROM) and as a computer data signal embodied in a computer usable (e.g., readable) transmission medium (such as a carrier wave or any other medium including digital, optical, or analog-based medium). As such, the code can be transmitted over communication networks including the Internet and intranets. It is understood that the functions accomplished and/or structure provided by the systems and techniques described above can be represented in a core (such as a GPU core) that is embodied in program code and can be transformed to hardware as part of the production of integrated circuits.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

What is claimed is:

1. A programmable logic system for controlling an external device, comprising:
a first processor;
one or more system input/output (I/O) modules coupled to the processor via an interface; and
a configurable hardware module coupled to the processor and the I/O modules via the interface.

2. The programmable logic system of claim 1, wherein the system is a programmable logic controller (PLC).

3. The programmable logic system of claim 1, wherein the external device includes a turbine engine.

4. The programmable logic system of claim 1, wherein the first processor includes at least one from the group including a central processing unit (CPU), a graphics processing unit (GPU), and an accelerated processing device (APD).

5. The programmable logic system of claim 1, wherein the configurable hardware module includes a field programmable gate array (FPGA).

6. The programmable logic system of claim 1, wherein the configurable hardware module includes;
an internal bus coupling the hardware module to the interface,
a field programmable gate array (FPGA) coupled to the bus, and
an external I/O module having one port coupled to the FPGA and another port configured for coupling to the external device.

7. The programmable logic system of claim 1, wherein the configurable hardware module includes;
an internal bus coupling the hardware module to the interface,
a second processor coupled to the bus, and
an external I/O module having one port coupled to the second processor and another port configured for coupling to the external device.

8. The programmable logic system of claim 7, wherein the second processor includes at least one from the a field programmable gate array (FPGA), a complex programmable logic device (CPLD), a central processing unit (CPU), a graphics processing unit (GPU), and an accelerated processing device (APD).

9. Programmable logic system of claim 7, wherein at least one of the first and second processors is a multicore processor.

10. The programmable logic system of claim 8, wherein the external I/O module is configurable to facilitate at least one of analog connectivity, digital connectivity, and communications.

11. Programmable logic system of claim 10, wherein the configurable hardware module is configured to provide safety integrity level 3 (SIL-3) functionality.

12. A configurable hardware module, comprising:
a bus configured for coupling the hardware module to an external interface;
a processor having a first port coupled to the bus; and
an external input/output (I/O) module having one port coupled to a second port of the processor and another port configured for coupling to an external device.

13. The configurable hardware module of claim 12, wherein the processor includes at least one from the group including a field programmable gate array (FPGA), a complex programmable logic device (CPLD), a central processing unit (CPU), a graphics processing unit (GPU), and an accelerated processing device (APD).

14. The configurable hardware module of claim 12, wherein the external I/O module is configurable to facilitate at least one of analog connectivity, digital connectivity, and communications.

15. The configuration hardware module of claim 14, wherein the external I/O module is safety integrity level 3 (SIL-3) certified.

16. A method for controlling operation of a device, comprising:
creating one or more configuration files related to the operation of the device;
programming configurable logic within a field programmable gate array (FPGA) in accordance with the configuration files; and
controlling the operation of the device with the programmed FPGA via an input output module.

17. The method of claim 16, further comprising using a processor to control the FPGA via a bus interface coupled thereto.

18. A computer readable medium having stored thereon computer executable instructions that, if executed by a computing device, cause the computing device to perform a method comprising:
creating one or more configuration files related to the operation of the device;
programming configurable logic within a field programmable gate array (FPGA) in accordance with the configuration files; and
controlling the operation of the device with the programmed FPGA via an input output module.

19. The computer readable medium of claim 18, further comprising using a processor to control the FPGA via a bus interface coupled thereto.

20. The computer readable medium of claim wherein the method is configured to provide safety integrity level 3 (SIL-3) functionality.
